(19) United States
(12) Patent Application Publication
(10) Pub. No.: US 2002/0155757 A1
(43) Pub. Date: Oct. 24, 2002

(54) Shield connector

(75) Inventor: Chikahiro Yoshioka, Nagoya-shi (JP)

Correspondence Address: OLIFF & BERRIDGE, PLC, P.O. BOX 19928, ALEXANDRIA, VA, 22320, US

(73) Assignee: AUTONETWORKS TECHNOLOGIES, LTD., Nagoya-shi (JP)

(21) Appl. No.: 10/126,521

(22) Filed: Apr. 22, 2002

(30) Foreign Application Priority Data
Apr. 23, 2001 (JP) 2001-123795

(51) Int. Cl. H01R 13/648

(52) U.S. Cl. 439/607

(57) ABSTRACT

A shielded connector, in which an inner conductor terminal 20 electrically connected to an end portion of a signal conductor 12 of a shielded cable 10 is housed in a dielectric housing 40 and an outer conductor shell 50 is attached to the dielectric housing 40, comprises a short circuit preventing piece 45 for restricting the inner conductor terminal 20 from rising so as to prevent the outer conductor shell 50 and the inner conductor terminal 20 from being short-circuited with each other, wherein the short circuit preventing piece 45 is arranged on a side wall face 44 of an exposed portion of a connecting portion of the inner conductor terminal 20 in the dielectric housing 40 with the signal conductor 12 of the shielded cable.

### BACKGROUND OF THE INVENTION

The present invention relates to a shielded connector. More particularly, the present invention relates to a shielded connector in which an inner conductor terminal connected with an end portion of a signal conductor of a shielded cable is housed in a dielectric housing while a connecting portion of the inner conductor terminal with the signal conductor of the cable is being exposed and further an outer conductor shell is attached to the dielectric housing.

A conventional shielded connector for housing an end portion of a shielded cable has been disclosed as shown in FIGS. 9 to 11. First of all, the shielded cable 100. includes: signal conductors 102 including conductors 103 and insulation internal sheaths 104 for covering the conductors 103; braided wires 106 for covering the outer circumferences of the signal conductors 102; and an insulation external sheath 108 for covering the braided wires 106. The insulating external sheath 108 at an end portion of the shielded cable 100 is peeled off, and the thus exposed braided wires 106 are folded back onto the circumferential face of the insulating external sheath 108. Under the above condition, an end portion of the cable 100 is connected with the shielded connector 110.

On the other hand, as components of the shielded connector 110 are shown in FIG. 10, the shielded connector 110 includes: an inner conductor terminal 120 electrically connected to the conductor 103 of the signal conductor 102; a dielectric housing 130 made of resin for housing the inner conductor terminal 120; and an outer conductor shell 140 made of metal for covering the dielectric housing 130.

As shown in FIG. 10, an assembling procedure of this shielded connector 110 is described as follows. First, the inner conductor terminal 120 is housed in the terminal housing chamber 132 arranged in the dielectric housing 130. As shown in FIG. 11, the inner conductor terminal 120 housed in the terminal housing chamber 132 can be prevented from coming out when the flexible engaging piece 124 arranged on an upper face of the inner conductor terminal 120 is engaged with the terminal housing chamber 132. On the rear side of the terminal housing chamber 132, there is provided a side wall face 134 from which an upper face of the connecting portion of the inner conductor terminal 120 with the signal conductor 102 is exposed.

Next, the dielectric housing 130, in which the inner conductor terminal 120 is housed, is inserted into the insertion hole 142 formed in the front portion of the outer conductor shell 140. The thus inserted the dielectric housing 130 is engaged with the flange 136 formed at the front portion of the dielectric housing 130. In this case, as shown in FIG. 11, the rising piece 144 arranged on a bottom face of the outer conductor shell 140 is engaged with the engaging hollow 138 formed on the reverse side of the dielectric housing 130, so that the dielectric housing 130 can be engaged in the drawing direction.

An end portion of the shielded cable 100 is connected with the shielded connector 110 assembled as described above. Specifically, as shown in FIGS. 9 and 11, the connection is conducted as follows. The end portion of the insulation internal sheath 104, the shielded cable 0.0 of which is exposed, is inserted from an upper portion into between two sets pressure contact blades 112a, 122b which are arranged on both side walls at the rear of the connecting terminal 120 being opposed to each other, so that the end portion of the insulation internal sheath 104 can be contacted to the pressure contact blades 112a, 122b with pressure. The insulation internal sheath 104 of the signal conductor 102 is torn apart by the pressure blades 122a, 122b. Therefore, the conductor 103 of the signal conductor and the inner conductor terminal 120 are electrically connected to each other.

When the shell cover 150 made of metal is attached to the end connecting portion of the shield cable 100, the end connecting portion can be electromagnetically shielded. In this case, when the side engaging piece 152 arranged on the side of the shell cover 150 is engaged with the side engaging hole 146 formed on the side of the outer conductor shell 140, the shell cover 150 can be engaged and fixed.

Finally, the braided wires 106, which are folded back, at the end portion of the shielded cable 100 and the circumferential face of the insulation external sheath 108 are calked with the crimp barrels 148L, 148R which are integrally arranged at the rear of the outer conductor shell 140. In this way, a connecting process for connecting the end portion of the shielded cable 100 with the shielded connector 110 is completed.

Concerning the means for shielding the end connecting portion of the shielded cable 100, instead of using the shell cover described above, a shielded connector structure is disclosed in which the upper open portion is completely shielded by the outer conductor shell.

However, the shielded connector structure composed as described above has the following disadvantages. The inner conductor terminal, with which the end portion of the signal conductor of the shielded cable is connected, is housed in and connected with the terminal chamber formed in the dielectric housing, however, an upper face of the connecting portion in which the inner conductor terminal is connected with the signal conductor of the cable is exposed. Accordingly, concerning the rear portion of the connecting S terminal located on the side wall face, the connecting terminals, which are adjacent to each other, can be prevented by both side walls from coming into contact with each other. However, the inner conductor terminal is not restricted at all when it moves upward. As a result, there is a possibility that the rear portion of the inner conductor terminal is raised due to a shock given to the inner conductor terminal and the inner conductor terminal comes into contact with the outer conductor shell made of metal or comes into contact with the shell cover electromagnetically shielding the connecting portion. That is, there is a possibility that the inner conductor terminal is short-circuited with a conductor.

Further, the following problems may be encountered. For example, this end connecting portion is given an external force and a hollow is caused on an upper face of the shielded cover or outer conductor shell. Due to the foregoing, the upper face of the shielded cover or outer conductor shell comes into contact with the rear end portion of the inner conductor terminal located right below it. As a result, there is a possibility that the conductor of the shielded cable and the outer conductor shell are electrically continued to each other and short-circuited.

In order to prevent the inner conductor terminal from being short-circuited with the shell cover or outer conductor shell, there is provided a means in which an insulation protective member made of resin is interposed between the inner conductor terminal in the terminal housing chamber and the shielded cover or outer conductor shell so that the inner conductor terminal can not come into contact with the outer conductor shell or shell cover. However, the following problems may be encountered in the above method. It becomes necessary to provide a volume sufficiently large for assembling the insulation protective member into the outer conductor shell. In order to ensure the above volume, it becomes necessary to extend the size of the shielded cover or outer conductor shell. As a result, the size of the entire shielded connector is expanded, and further the number of parts is increased, which deteriorates the productivity.

A task to be accomplished by the present invention is prevention of the contact and short circuit of the connecting portion in which the end portion of the shielded cable is connected with the shielded connector so as to enhance the reliability of the terminal connecting portion.

### SUMMARY OF THE INVENTION

In order to solve the above problems, the present invention described in aspect 1 provides a shielded connector in which an inner conductor terminal electrically connected to an end portion of a signal conductor of a shielded cable is housed in a dielectric housing and an outer conductor shell is attached to the dielectric housing, the shielded connector comprising a short circuit preventing piece for restricting the inner conductor terminal from rising so as to prevent the outer conductor shell and the inner conductor terminal from being short-circuited with each other, wherein the short circuit preventing piece is arranged on a side wall face of an exposed portion of a connecting portion of the inner conductor terminal in the dielectric housing with the signal conductor of the shielded cable.

In the shielded connector composed as described above, the inner conductor terminal housed in the terminal housing chamber provided in the dielectric housing is prevented from moving (rising) upward by the short circuit preventing piece arranged at the upper end edge on the side wall of the terminal housing chamber. Accordingly, in the shielded connector in which an upper portion of the connecting portion of the shielded cable end portion with the inner conductor terminal is shielded by the outer conductor shell, even when the connecting portion of the inner conductor terminal is going to rise upward by a shock given to the connector, the connecting portion of the inner conductor terminal is prevented from moving. Therefore, it is possible to avoid that the inner conductor terminal and the outer conductor shell are contacted and short-circuited with each other.

It becomes unnecessary to interpose an insulation protective member and others between the inner conductor terminal and outer conductor shell. Therefore, the shielded connector can be downsized and the number of parts of the connector can be reduced and further the number of manufacturing processes can be reduced.

As described in aspect 2, the present invention provides a shielded connector in which a shell cover for electromagnetically shielding the connecting portion of the inner conductor terminal housed in the dielectric housing with the signal conductor of the cable is arranged in the exposed portion of the connecting portion in such a manner that the shell cover is engaged with the outer conductor shell. Even when an upper portion of the exposed portion of the connecting portion, in which the inner conductor terminal in the dielectric housing and the cable signal conductor are connected with each other, is not shielded by the outer conductor shell, when the shell cover is engaged with and attached to the outer conductor shell, this connecting portion can be electromagnetically shielded. Therefore, the reliability of connection of the end portion of the shielded cable can be ensured. Further, in this case, the short circuit preventing piece is arranged on the side wall face. Therefore, it is possible to avoid that the inner conductor terminal and this shell cover are contacted and short-circuited with each other.

As described in aspect 3, it is preferable that a cross section of the short circuit preventing piece, which is arranged in the dielectric housing composing the shielded connector, is formed into an umbrella-shape so that the short circuit preventing piece can be engaged with the inner conductor terminals arranged on both sides of bulkheads. When the cross section is formed into an umbrella-shape, the following advantages can be provided. Since an upper face of the short circuit preventing piece is tapered, the signal conductor can be smoothly inserted into and connected with the inner conductor terminal, which is housed in the dielectric housing, from an upper portion. In addition to that, in the case where an inner conductor terminal having a pressure blade is used, the signal conductor to be inserted can be smoothly guided by this umbrella-shaped short circuit preventing piece, and further the signal conductor can be accurately positioned at the center of the pressure blade. Therefore, the reliability of connection can be more enhanced.

### BRIEF DESCRIPTION OF THE DRAWINGS

[FIG. 1]

FIG. 1 is an exploded perspective view of connector members used for connecting an end portion of a shielded cable in a shielded connector of Embodiment 1 of the present invention.

[FIG. 2]

FIG. 2 is a perspective view of a dielectric housing structure in the connector members shown in FIG. 1.

[FIG. 3]

FIG. 3 is a rear view of the dielectric housing shown in FIG. 2.

[FIG. 4]

FIG. 4 is a perspective view of a connecting process of connecting a shield connector including connector members with an end portion of a shielded cable.

[FIG. 5]

FIG. 5 is a sectional view of a connecting process of connecting the shielded connector shown in FIG. 4 with an end portion of the shielded cable.

[FIG. 6]

FIG. 6 is an exploded perspective view of connector members used for connecting an end portion of a shielded cable in a shielded connector of Embodiment 2 of the present invention

[FIG. 7]

FIG. 7 is a perspective view of a connecting process of connecting a shield connector, which includes the connector members shown in FIG. 6, with an end portion of a shielded cable.

[FIG. 8]

FIG. 8 is a sectional view of a connecting process of connecting the shielded connector shown in FIG. 7 with an end portion of a shielded cable.

[FIG. 9 ]

FIG. 9 is a perspective view showing a connecting state in which a conventional shielded connector and an end portion of a shielded cable are connected with each other.

[FIG. 10]

FIG. 10 is a perspective view showing the shielded connector members shown in FIG. 9.

[FIG. 11]

FIG. 11 is a sectional view of the connecting state shown in FIG. 9.

### DETAILED DESCRIPTION OF THE PREFERRED EMBODIMENTS

Referring to the drawings, a terminal treatment structure of a shielded cable of an embodiment of the present invention will be explained below in detail.

(EMBODIMENT 1)

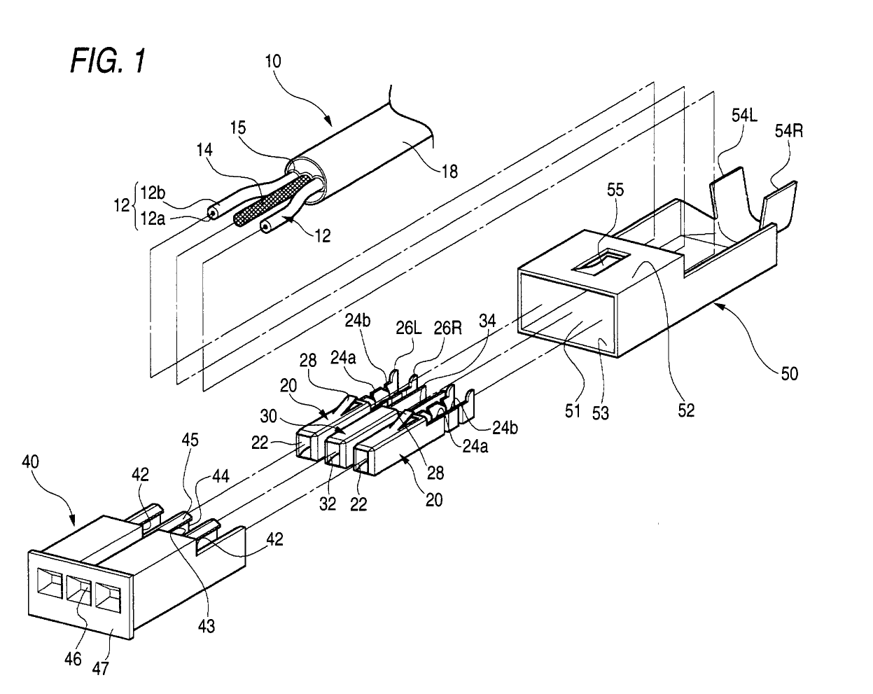

Referring to FIGS. 1 to 5, the present embodiment will be explained as follows. The shielded cable 10 used for the present embodiment includes: two signal conductors 12, each signal conductor 12 including a conductor 12a and an insulation inner sheath 12b covering the conductor 12a; and a drain conductor 14 including a plurality of twisted element wires. These signal conductors 12 and drain conductor 14 are covered with the metallic foil 15 in a lump. Further, the outer circumference of this metallic foil 15 is covered with the insulation external sheath 18.

An end portion of this shielded cable 10 is connected with the shielded connector member shown in FIG. 1. This shielded connector member includes: an inner conductor terminal 20 with which an end portion of the signal conductor 12, which is exposed when the metallic foil 15 and insulation external sheath 18 of the shielded cable 10 are peeled away, is connected; a drain conductor terminal 30 with which an end portion of the drain conductor 14, which is exposed in the same manner, is connected; a dielectric housing 40 for housing the inner conductor terminal 20 and drain conductor terminal 30; and an outer conductor shell 50 covering the periphery of the dielectric housing 40. Components of the shielded connector will be explained as follows.

First of all, the structure of the inner conductor terminal 20 and that of the drain conductor terminal 30 will be explained. As shown in FIG. 1, the inner conductor terminal 20 has a terminal insertion hole 22 at the front portion into which a connecting terminal of an opponent connector is inserted and connected. On both side walls at the rear portion, there are provided two pairs of pressure blades 24a, 24b which are opposed to each other. An end portion of the signal conductor 12 comes into pressure contact with these pressure blades 24a, 24b. Specifically, when the end portion of the signal conductor 12 comes into pressure contact with the pressure blades 24a, 24b, the insulation internal sheath 12b of the signal conductor 12 is torn apart by the pressure blades 24a, 24b, and the signal conductor 12a inside the insulation internal sheath 12b comes into contact with the pressure blades 24a, 24b, and the signal conductor 12 and inner conductor terminal 20 are electrically connected to each other.

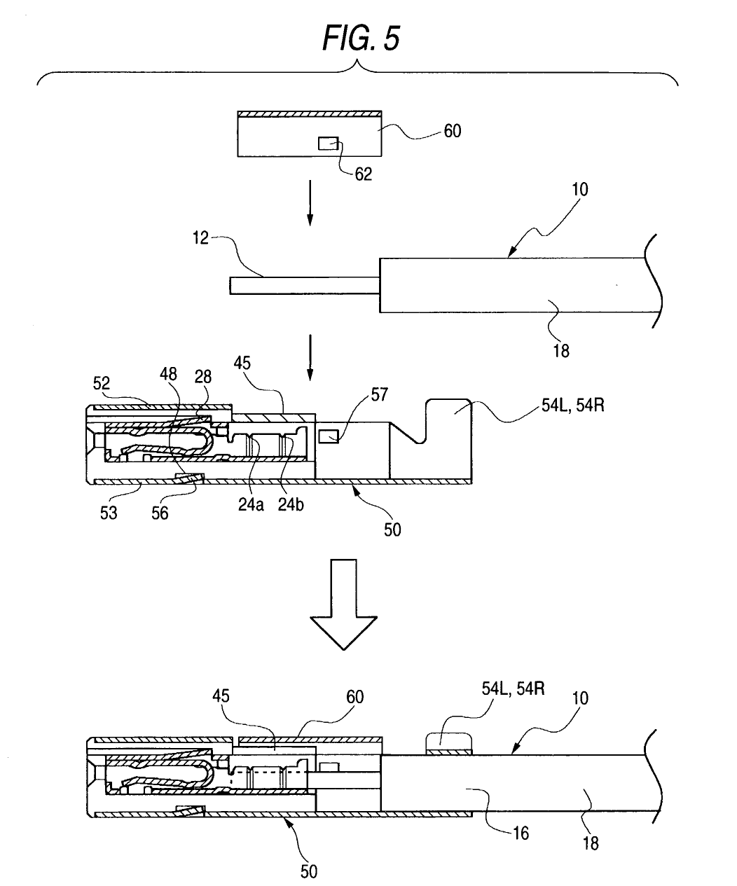

At the rear portions of the pressure blades 24a, 24b, there are provided signal conductor barrels 26L, 26R for holding the end portion of the signal conductor 12 which has been connected to the inner conductor terminal 20 with pressure. On the other hand, as shown in FIG. 5, on an upper face of the inner conductor terminal 20, there is provided a flexible engaging piece 28 for engaging the inner conductor terminal 20 with the housing chamber 42 so that the inner conductor terminal 20, which is housed in the terminal housing chamber 42, can be prevented from coming out from the housing chamber 42.

The drain conductor terminal 30 has a terminal insertion hole 32 at the front portion into which a drain conductor terminal of an opponent connector (not shown) is inserted and connected. On the other hand, the rear portion becomes a drain conductor connecting portion 34 formed by both side wall faces so as to connect an end portion of the drain conductor 14. When the end portion of the drain conductor 14 is connected to the drain conductor connecting portion 34 by means of welding, soldering or pressure welding, the drain conductor 14 is electrically connected to the drain conductor terminal 30. An end portion of the drain conductor terminal 30 preferably comes into pressure contact in a same way as the inner conductor terminal 20.

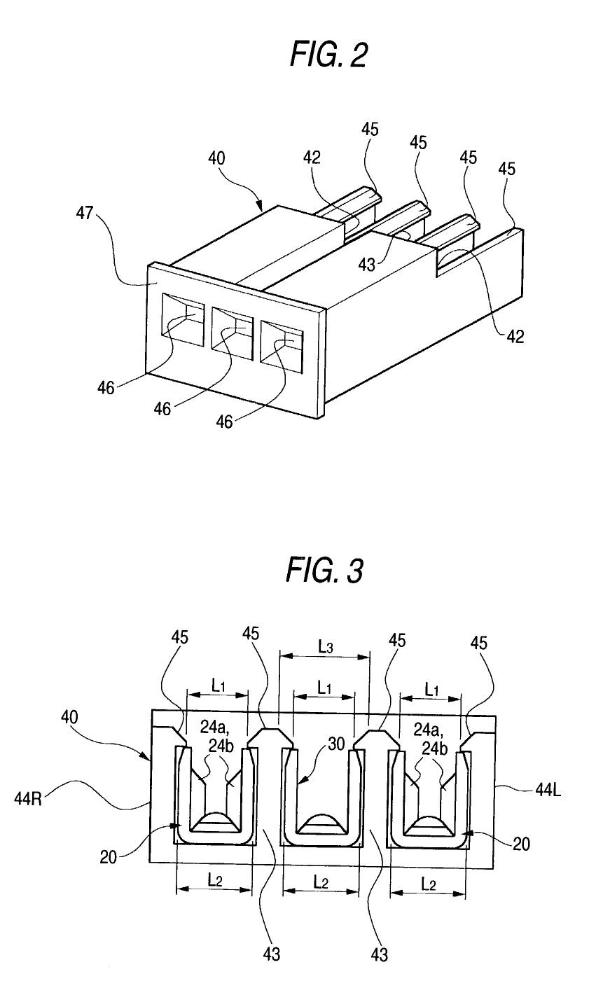

Next, the structure of the dielectric housing 40 will be explained below. This dielectric housing 40 is made of resin. As shown in FIGS. 1 and 2 being enlarged, in the dielectric housing 40, there are provided a terminal housing chamber 42 in which the inner conductor terminal 20 is housed and a terminal housing chamber 43 in which the drain conductor terminal 30 is housed. The rear side of the terminal housing chambers 42, 43, in which the connecting portions of the inner conductor terminal 20 and drain conductor terminal 30 with the end portion of the shielded cable 10 are housed, is formed into the side wall face 44, only the upper face of which is open. In this case, the inner conductor terminals 20 are housed in the terminal housing chambers 42 arranged on both sides of the dielectric housing 40, and the drain conductor terminal 30 is housed in the terminal housing chamber 43 arranged at the center of the dielectric housing 40.

At the upper end edges of the side wall faces 44 of the terminal housing chambers 42, 43, there are provided short circuit preventing pieces 45 for restricting movements in the upward direction of the inner conductor terminal 20 and drain conductor terminal 30, and these short circuit preventing pieces 45 are protruded in the longitudinal direction being protruded. Cross sections of these short circuit preventing pieces 45 are formed into an umbrella-shape, the upper face of which is tapered, for the following reasons. In order to prevent the inner conductor terminal and the drain terminal 30, which are housed in the terminal housing chambers 42, 43, from rising upward, these short circuit preventing pieces 45 are engaged with the terminals. In order to easily insert and connect the end portions of the signal conductor 12 and the drain conductor 14 of the shielded cable 10 from an upper portion, cross sections of these short circuit preventing pieces. 45 are formed into an umbrella-shape, the upper face of which is tapered.

In this embodiment, the short circuit preventing piece 45 is arranged on the side wall face 44 of the terminal housing chamber 43 of the drain conductor terminal. Since the drain conductor terminal 30 must be electrically connected to the outer conductor shell 50, it is essentially unnecessary to take countermeasures for preventing the occurrence of a short circuit. However, the short circuit preventing piece 45 is provided so that an unnecessary problem such as a short circuit of the conductor 12a of the signal conductor 12 with the outer conductor shell 50 or a short circuit of the conductor 12a of the signal conductor. 12 with the shell cover 60 can not be caused when the drain conductor terminal 30 is moved. For the above reasons, no problems are caused even when the connector does not include the short circuit preventing piece 45 exclusively used for the drain conductor,

FIG. 3 is a rear view showing a state in which the inner conductor terminals 20 and the drain conductor terminal 30 are housed in the respective terminal housing chambers 44. Width L₁ between the end portions of the short circuit preventing pieces 45 arranged at the upper end edges of the side wall faces 44 is smaller than width L_{z} of the inner conductor terminal 20 and the drain conductor terminal 30. Therefore the inner conductor terminal 20 and drain conductor terminal 30 are restricted from moving upward. Width L₃ between the upper end edges of the tapered face of the short circuit preventing pieces 45 is larger than outer diameters of the signal conductor 12 and the drain conductor 14 which are inserted into and connected with the inner conductor terminal 20 from an upper portion.

As shown in FIG. 2, an upper face of the terminal housing chamber 43 for housing the drain conductor terminal 30 is open so that the contact piece 55, which is capable of elastically coming into contact with an end portion of the drain conductor terminal 14, arranged on the upper face 52 of the outer conductor shell 50 described later can be engaged with the opening. On the other hand, in the front portion of the dielectric housing 40, there are provided insertion holes 46 into which the connecting terminals of the opponent connectors are inserted so that the connecting terminals of the opponent connectors can be inserted into and connected with the terminal insertion holes 22 of the inner conductor terminal 20 and the terminal insertion hole 32 of the drain conductor terminal 30 housed in the terminal housing chambers 42, 43.

Further, on the front face on which these insertion holes 46 are formed, there is provided a flange 47 for restricting an excessive insertion of the dielectric housing 40 into the outer conductor shell 50. Although not shown in FIG. 1, on the reverse side of the dielectric housing 40, there is provided an engaging hollow 48 for engaging with the rising engaging piece 56 which is arranged on the bottom face 53 of the outer conductor shell 50 shown in FIG. 5.

Next, the structure of the outer conductor shell 50 will be explained below. The outer conductor shell 50 is made of metal. In the front portion of the outer conductor shell 50, there is provided an insertion hole 51 into which the dielectric housing 40 is inserted. On the other hand, at the rear portion of the outer conductor shell 50, there are provided a pair of crimp-style barrels 54L, 54R, which are opposed to each other, for holding the circumferential face of the shielded cable 10, which has been subjected to terminal treatment, by calking.

On the upper face 52 of the outer conductor shell 50, there is provided a rising contact piece 55 which is elastically coming into contact with the upper face of the drain conductor terminal 30 housed in the terminal housing chamber 43.

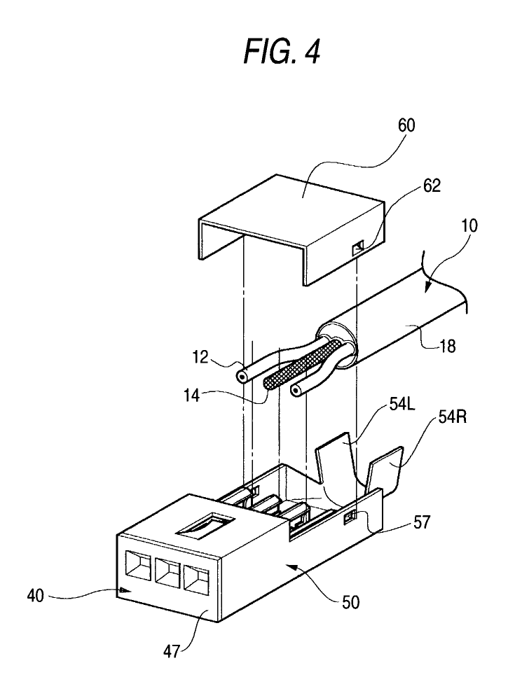

On the bottom face 53 of the outer conductor shell 50, there is provided a rising engaging piece 56, which is formed being directed backward, to be engaged with the engaging hollow 48 formed on the reverse side of the dielectric housing 40 so that the dielectric housing 40 can be engaged. On the side at the rear of the outer conductor shell 50, as shown in FIGS. 4 and 5, there is provided a rectangular side engaging hole 57 for engaging the shell cover 60 with the outer conductor shell 50 when the rectangular side engaging hole 57 is engaged with the side engaging piece 62 arranged on the side of the shell cover 60.

Next, referring to FIGS. 1, 4 and 5, specific explanations will be made into a process in which the shielded cable 10 is incorporated into the connector members. FIG. 4 is a perspective view showing a state in which an end portion of the shielded cable 10 is connected to the shielded connector which is assembled from the connector members shown in FIG. 1. FIG. 5 is a sectional view of a process in which an end portion of the shielded cable 10 shown in FIG. 4 is connected.

First, as shown in FIG. 1, the inner conductor terminals 20 are inserted into the terminal housing chambers 42 arranged in the dielectric housing 40. As shown in FIG. 5, when this insertion of the inner conductor terminals 20 has been completed, the flexible engaging piece 28 arranged on the upper face of the inner conductor terminal 20 is engaged with the terminal housing chamber 42. The drain conductor terminal 30 is inserted into the central terminal housing chamber 43 of the dielectric housing 40 in the same manner.

Next, the dielectric housing 40 is inserted into the insertion hole 51, which is formed in the front portion of the outer conductor shell 50, and engaged with the flange 47 provided on the front face of the dielectric housing 40, so that the dielectric housing 40 can not be inserted any more. At the same time, the rising engaging piece 56 formed on the bottom face 53 of the outer conductor shell 50 is engaged with the engaging hollow 48 formed on the reverse side of the dielectric housing 40, so that the dielectric housing 40 can be engaged with the outer conductor shell 50. In the above state, movements of the dielectric housing 40 in the pushing and drawing directions are restricted. Therefore, the dielectric housing 40 can be positively prevented from coming out from the outer conductor shell 50.

At this time, the contact piece 55 arranged on the upper face 52 of the outer conductor shell 50 comes into contact with the upper face of the drain conductor terminal 30 housed in the terminal housing chamber 43 of the dielectric housing 40, so that the outer conductor shell 50 and the drain conductor 14 can be electrically continued to each other.

As shown in FIGS. 4 and 5, the thus assembled connector member is connected to an end portion of the shielded cable 10. As described before, the metallic foil 15 and the insulation external sheath 18 at the end portion of the shielded cable 10 are peeled away so as to expose the signal conductors 12 and the drain conductor 14. The thus exposed signal conductors 12 and the drain conductor 14 are inserted into and connected with the inner conductor terminals 20 and the drain conductor terminal 30, which are respectively housed in the terminal housing chambers 42, 43 of the dielectric housing 40, from an upper portion.

Specifically, the connection is made as follows. The end portions of the signal conductors 12 are respectively made to come into pressure contact with the pressure blades 24a, 24b arranged at the rear of the inner conductor terminals 20, so that the conductors 12a of the signal conductors 12 can be electrically continued to the inner conductor terminals 30. Further, the signal conductor barrels 26L, 26R arranged at the rear of the inner conductor terminals 30 are pressed against and held on the circumferential face of the insulation internal sheath 12b. In this way, the signal conductors 12 are connected with the inner conductor terminal 30. On the other hand, concerning the drain conductor 14, the end portion of the drain conductor 14 is connected with the rear portion of the drain terminal 30 by means of welding, soldering or pressure welding.

Next, the circumferential face of the insulation external sheath 18 of the shielded cable 10 is calked and held by the crimp-type barrels 54L, 54R which are integrally arranged at the rear of the outer conductor shell 50.

The metallic shell cover 60 is engaged with the outer conductor shell 50 so that the metallic shell cover 60 can be set in an upper portion of the end portion of the shielded cable 10. In this way, the end connecting portion of the shielded cable 10 can be electromagnetically shielded. At this time, when the side engaging piece 62 arranged on the side of the shell cover 60 is engaged with the side engaging hole 57 formed on the side of the outer conductor shell 50, the shell cover 60 can be engaged and fixed. Finally, when the thus assembled outer conductor shell 50 is covered with a housing cover not shown in the drawing, manufacturing the shielded connector is completed.

As long as the shielded connector having the above structure is used, even if a shock is given to the connector from the outside, the inner conductor terminals 20 are not shifted upward because the upward movements of the inner conductor terminals 20 are prevented by the short circuit preventing pieces 45 arranged at the upper end edges of the side wall faces 44 of the dielectric housing 40. Accordingly, there is no possibility that the inner conductor terminals 20 are contacted with the shielded cover 60 which covers the end connecting portion of the shielded cable 10.

(EMBODIMENT 2)

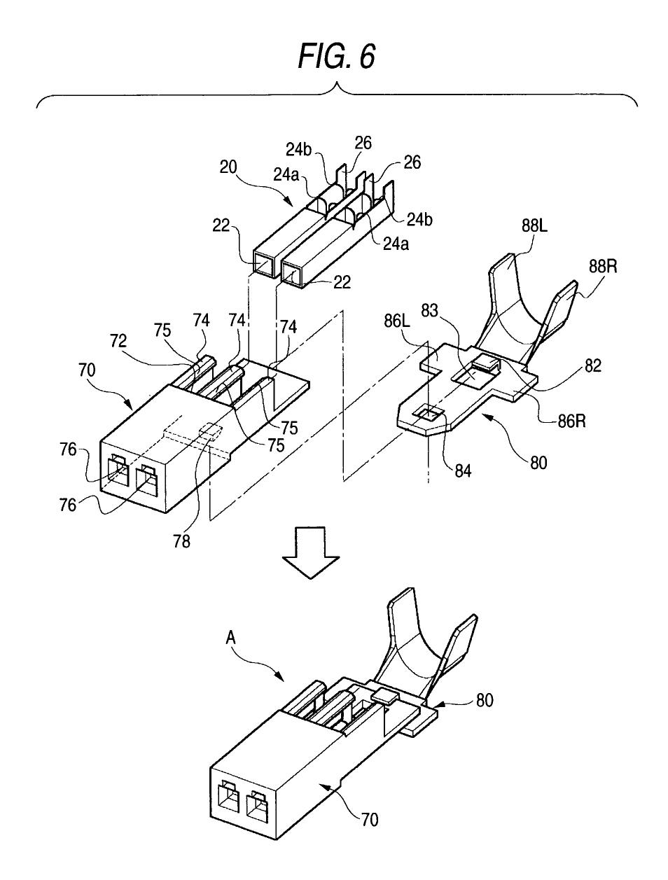

Referring to FIGS. 6 to 8, the present embodiment will be explained below. First of all, the shielded cable 10 used for the present embodiment includes: two signal conductors 12, each signal conductor 12 including a conductor 12a and an insulation inner sheath 12b covering the conductor 12a; braided wires 16 covering these signal conductors 12; and insulation external sheaths 18 covering an outer circumference of the braided wires 16.

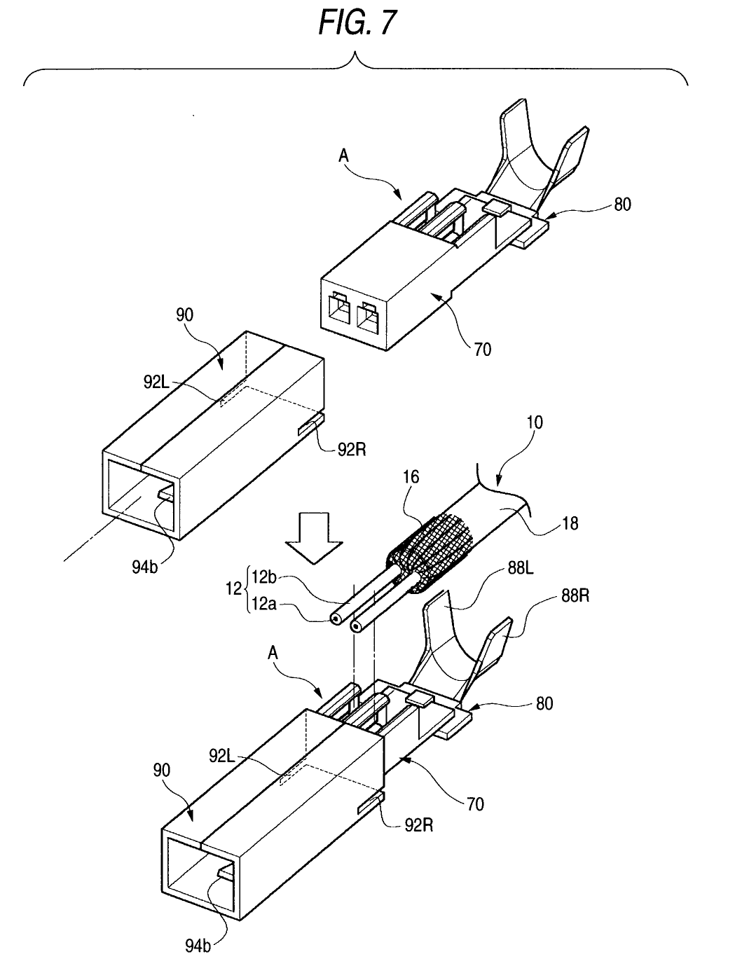

The connector member shown in FIG. 6 includes: inner conductor terminals 20 connecting with the signal conductors 12 which are exposed when the braided wires 16, which are exposed by peeling the insulation outer sheaths 18 of the above shielded cable 10, are folded back onto the insulation outer sheath 18 side; a dielectric housing 70 for housing the above inner conductor terminals 20; a shell connecting terminal 80 connecting with this dielectric housing 70; and an outer conductor shell 90 (shown in FIG. 7) for housing the assembled body A of these members and for shielding the end portion of the shielded cable 10.

First of all, the structure of the inner conductor terminal 20 will be explained. This inner conductor terminal 20 is made of resin. As shown in FIG. 6, the inner conductor terminal 20 has a terminal insertion hole 22 at the front portion into which a connecting terminal of an opponent connector is inserted and connected. On the other hand, on both side walls at the rear portion of the inner conductor terminal 20, there are provided two pairs of pressure blades 24a, 24b which are opposed to each other. An end portion of the signal conductor 12 comes into pressure contact with these pressure blades 24a, 24b, so that the signal conductor 12 can be connected to the inner conductor terminal 20.

Specifically, when the end portion of the signal conductor 12 comes into pressure contact with the pressure blades 24a, 24b, the insulation internal sheath 12b of the signal conductor 12 is torn apart by the pressure blades 24a, 24b, and the signal conductor 12a inside the insulation internal sheath 12b comes into contact with the pressure blades 24a, 24b, and the signal conductor 12 and inner conductor terminal 20 are electrically connected to each other. At the rear portions of the pressure blades 24a, 24b, there are provided signal conductor barrels 26L, 26R for holding the end portion of the signal conductor 12 which has been connected to the inner conductor terminal 20 with pressure.

Next, the structure of the dielectric housing 70 will be explained below. As shown in FIG. 6, this dielectric housing 70 includes: terminal housing chambers 72 for housing the inner conductor terminals 20; and side wall faces 74, the upper faces of which are open. At the upper end edges of the side wall faces 74, there are provided short circuit preventing pieces 75 for preventing movements of the inner conductor terminals 20 housed in the terminal housing chambers 72, wherein these short circuit preventing pieces 75 are protruded in the longitudinal direction being opposed to each other. A cross section of each short circuit preventing piece 75 is formed into an umbrella-shape, the upper face of which is tapered, so that the inner conductor terminal can be easily engaged with the short circuit preventing piece for preventing the inner conductor terminal 20, which is housed in the terminal housing chamber 72, from rising upward and the end portion of the signal conductor 12 of the shielded cable 10 can be easily inserted and connected from an upper portion.

In the front portion of the dielectric housing 70, there are provided insertion holes 76 into which connecting terminals of the opponent connector are inserted so that the connecting terminals of the opponent connector can be inserted and connected to the terminal insertion holes 22 of the inner conductor terminals 20 housed in the terminal housing chambers 72. As shown by broken lines in FIG. 6, on the reverse side of the dielectric housing 70, there is provided an engaging protrusion 78 to be engaged with the engaging hollow 84 formed in the shell connecting terminal 80 described later.

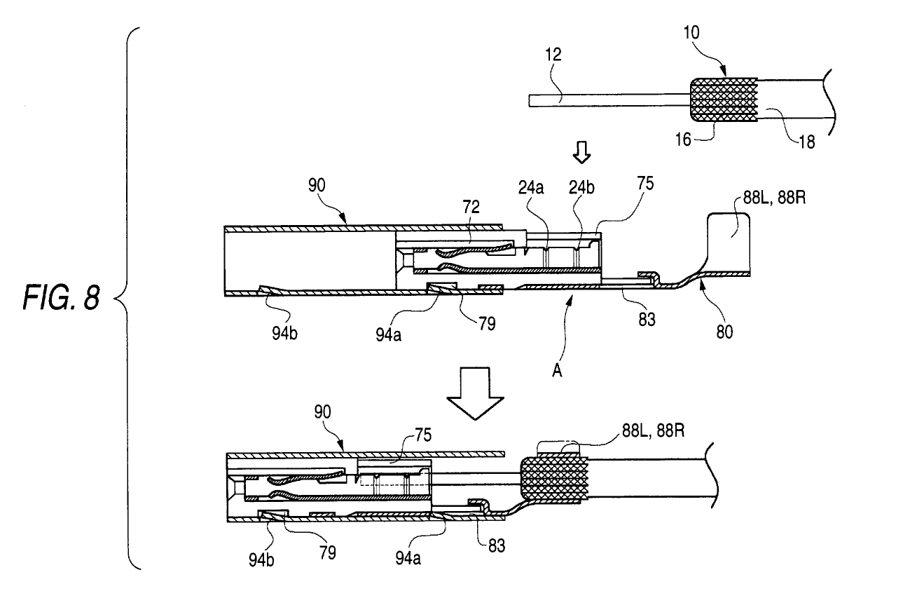

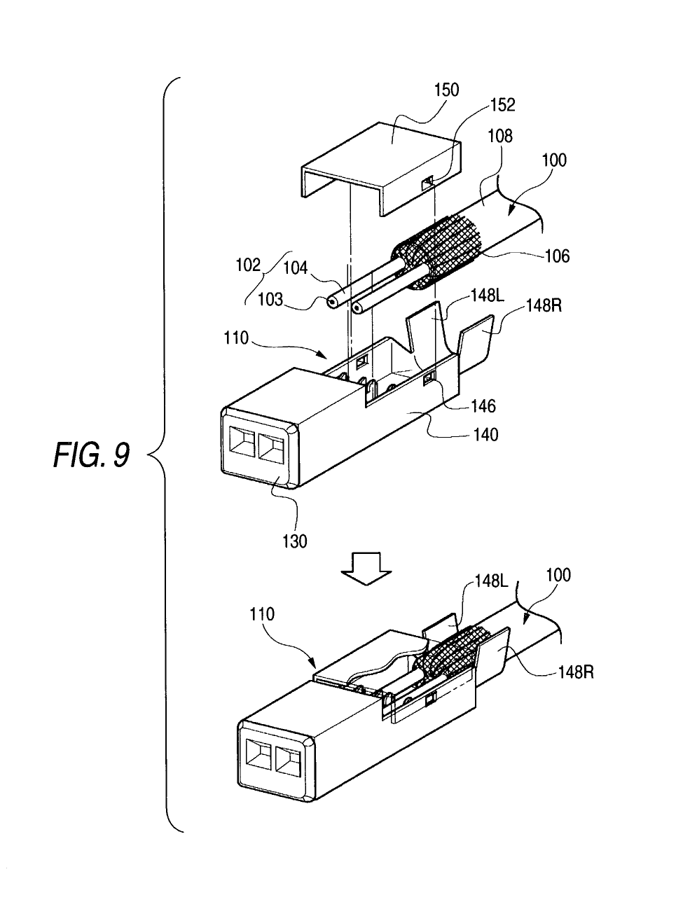

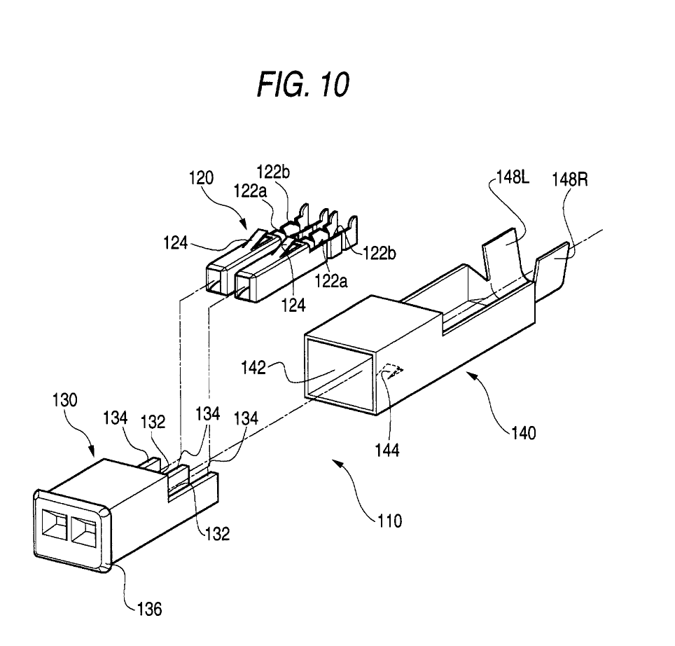

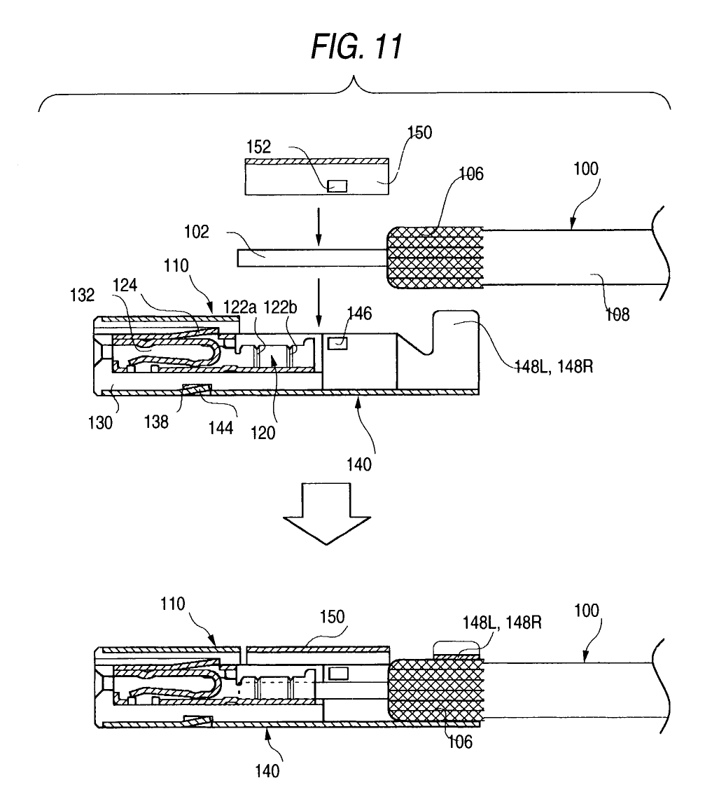

As described later referring to FIG. 8, on the reverse side of the dielectric housing 70, there is provided an engaging hollow 79 to be engaged with the first rising engaging piece 94a and the second rising engaging piece 94b which are arranged on the bottom face of the outer conductor shell 90.

Next, the structure of the shell connecting terminal 80 will be explained below. This shell connecting terminal 80, which is made of metal; is a member interposed between the braided wires 16 of the shielded cable and the outer conductor shell described later so that they can be electrically continued to each other. In this shell connecting terminal 80, there is provided an L-shaped stopping piece 82 for stopping a rear end edge of the dielectric housing 70 to be connected. This L-shaped stopping piece 82 is formed being raised from the shell connecting terminal 80. when this stopping piece 82 is raised, the engaging hole 83 to be engaged with the second rising engaging piece 94b, which is provided in the outer conductor shell 90 described later, is formed in the shell connecting terminal 80.

In the front portion of the shell connecting terminal 80, there is provided a rectangular engaging hole 84 which is engaged with the engaging protrusion 78 formed in the dielectric housing 70 and becomes a positioning means for positioning the dielectric housing 70 together with the stopping piece 82.

On both sides of the shell connecting terminal 80, there are provided rectangular side engaging pieces 86L, 86R to be engaged with the rectangular cutout portions 92L, 92R formed on both side wall faces at the rear of the outer conductor shell 90, when the shell connecting terminal 80 is inserted into the outer conductor shell 90, so as to restrict a movement of the shell connecting terminal. 80 in the inserting direction as shown in FIG. 7.

At the rear portion of the shell connecting terminal 80, there are provided pressure barrels 88L, 88R, which are formed being integrated with the shell connecting terminal 80, for holding a circumferential face of the insulation external sheath 18 of the shielded cable 10, the signal conductors 12 of which have been connected with the inner conductor terminals 14.

These connector members are assembled as follows. First, the inner conductor terminals 20 are housed in the terminal housing chambers 72 formed in the dielectric housing 70. After that, the rear end edge of the dielectric housing 70 is contacted with and stopped at the stopping piece 82 of the shell connecting terminal. 80, and the engaging protrusion 78 provided on the reverse side of the dielectric housing 70 is engaged with the engaging hole 84 formed in the shell connecting terminal 80, so that the dielectric housing 70 can be positioned and fixed at the shell connecting terminal 80. This body, which has been assembled from three connector members, is referred to as an assembled body A.

As shown in FIG. 7, this assembled body A is inserted into the outer conductor shell 90 for electromagnetically shielding an end portion of the shielded cable 10 to be connected. On both side walls at the rear portion (on the insertion end side of the assembled body A) of this outer conductor shell 90, there are provided rectangular cutout portions 92L, 92R to be engaged with the side engaging pieces 86L, 86R of the shell connecting terminal 80.

As shown in FIG. 8, on the bottom face of the outer conductor shell 90, there are provided a first rising engaging piece 94a and second rising engaging piece 94b which are directed in the direction opposite to the direction of the insertion side of the assembled body A. These first rising engaging piece 94a and second rising engaging piece 94b are engaged with the engaging hollows 79 formed on the reverse side of the dielectric housing 70 when the assembled body A is inserted into the outer conductor shell 90 so that the assembled body A can be engaged with the outer conductor shell 90.

Next, referring to FIGS. 7 and 8, the specific terminal treatment process of the shielded cable 10 will be explained below. First, as shown in FIG. 7, the assembled body A including the inner conductor terminal. 20, dielectric housing 70 and shell connecting terminal 80 is inserted into the outer conductor shell 90. At this time, as shown in FIG. 8, the first rising engaging piece. 94a formed on the bottom face of the outer conductor shell 90 is engaged with the engaging hollow 79 formed on the reverse side of the dielectric housing 70. Therefore, the assembled body A, which has been inserted, is temporarily engaged in the outer conductor shell 90.

In the above state in which the assembled body A is temporarily engaged in the outer conductor shell 90, the shielded cable 10, the signal conductors 12 of which are exposed by peeling the insulation external sheaths 18 at the end portions, is inserted and connected to the terminal connecting portion of the assembled body A from an upper portion. Specifically, as shown in FIGS. 7 and 8, the exposed signal conductors 12 are respectively made to come into pressure contact with the pressure blades 24a, 24b of the inner conductor terminals 20 housed in the terminal housing chambers 72 of the housing 70, so that the conductors 12a of the signal conductors 12 are connected to the inner conductor terminals 20. Next, as shown in FIG. 7, a circumferential face of the insulation external sheath 18 at the end portion of the shielded cable 10 is pressed and held by the crimp-type barrels 88L, 88R which are integrally arranged at the rear of the shell connecting terminal 80.

After the above process has been completed, the assembled body A is further inserted from the temporarily engaged state into the outer conductor shell 90. Then, the side engaging pieces 86L, 86R, which are arranged at the shell connecting terminal 80 as shown in FIG. 7, are engaged and contacted with the cutout portions 92L, 92R formed on both side wall faces at the rear of the outer conductor shell 90. Therefore, further insertion of the assembled body A into the outer conductor shell 90 is restricted.

At the same time, as shown in FIG. 8, the second rising engaging piece 94b formed on the bottom face of the outer conductor shell 90 is engaged with the engaging hollow 79 formed on the reverse side of the dielectric housing 70. Further, at the rear of the second rising engaging piece 94b the first rising engaging piece 94a is engaged with the engaging hole 83 of the shell connecting terminal 80. In this way, the assembled body A is truly engaged with the outer conductor shell 90,

Since the respective rising engaging pieces 94a, 94b are formed being directed in the direction opposite to the direction of insertion of the assembled body A, movements of the assembled body A and the shielded cable 10 in the drawing direction are restricted in this truly engaging state. That is, the movements of the assembled body A and the shielded cable 10 are restricted at the end portions so that they can not be moved in any of the pushing direction and the drawing direction. Therefore; the assembled body A can be positively connected with the outer conductor shell 90.

Further, as shown in FIG. 8, the end connecting portion of the shielded cable 10 is completely covered with the outer conductor shell 90. Therefore, the end connecting portion of the shielded cable 10 can be completely electromagnetically shielded.

In this shielded connector composed as described above, even when a shock is given to the connector from the outside and the inner conductor terminals 20 are going to be shifted upward, the movement of the inner conductor terminals 20 are prevented by the short circuit preventing pieces 75 arranged at the upper end edges of the side wall faces 74. Accordingly, there is no possibility that the inner conductor terminals 20 come into contact with the upper face 52 of the outer conductor shell 90 which covers the terminal connecting portion of the shielded cable 10.

It should be noted that the present invention is not limited to the above specific embodiment, and variations may be made by one skilled in the art without departing from the spirit and scope of the present invention. For example, in the above embodiment, concerning the short circuit preventing piece for preventing the inner conductor terminal and drain conductor terminal, which are housed in the dielectric housing, from rising upward, the cross section of the short circuit preventing piece is: formed into an umbrella-shape, the upper face of which is tapered. However, the shape of the short circuit preventing piece is not limited to the above specific embodiment, but it is possible that the short circuit preventing piece is formed into a semicircle, rectangle and so forth.

In the above embodiment, these short circuit preventing pieces are protruded in the longitudinal direction being continuously opposed to each other. However, the shape of each short circuit preventing piece is not limited to the above specific embodiment. As long as the short circuit preventing pieces can prevent the inner conductor terminals from rising, they may be intermittently formed. Further, it is unnecessary for the short circuit preventing pieces to be protruded being opposed to each other. It is possible to adopt a structure in which these short circuit preventing pieces are arranged only on one side.

In the above embodiment, the short circuit preventing pieces are arranged at the upper end edges of the side wall faces of the dielectric housing. However, the short circuit preventing pieces are not necessarily arranged at the upper end edges of the side wall faces of the dielectric housing. As long as the short circuit preventing pieces can prevent the inner conductor terminals from rising, of course, it is possible to arrange these short circuit preventing pieces on the side wall faces.

In the above embodiment, in the shielded connector in which an upper portion of the connecting section of the shielded cable with the inner conductor terminal is open, and the shell cover is attached to the upper portion of the connecting section. However, it should be noted that this shell cover may be attached when necessary, that is, this shell cover is not necessarily attached.

In the above embodiment, the shielded cable connected with the shielded connector having the shielded cover has the drain conductor. On the other hand, in the explanation of the shielded connector, the end portion of the shielded cable of which is completely covered with the outer conductor shell, the shielded cable including braided wires is used. However, the shielded cable to be used in each embodiment may have a drain conductor or braided wires.

In the above embodiment, the inner conductor terminal, with which the end portion of the shielded cable is connected, has pressure blades at the rear portion. However, the connecting method of connecting the shielded cable with inner conductor terminal is not limited to the above specific embodiment. For example, it is possible to adopt a method in which an insulation body of a signal conductor is peeled off, and the thus exposed conductor is connected with an inner conductor terminal by means of welding or soldering.

According to the shielded connector of aspect 1 of the present invention, a short circuit preventing piece for restricting an upward movement of an inner conductor terminal housed in a terminal housing chamber is arranged at an upper end edge on a side wall face composing the terminal housing chamber of a dielectric housing in which the inner conductor terminal is housed. Accordingly, in the shielded connector in which an upper portion of the connecting portion of the shielded cable end portion with the inner conductor terminal is shielded by the outer conductor shell, even when the connecting portion of the inner conductor terminal is going to rise upward by a shock given to the connector from the outside, the connecting portion of the inner conductor terminal is prevented from moving by the short circuit preventing piece arranged at the upper end edge of the side wall face. Therefore, it is possible to avoid that the inner conductor terminal and the outer conductor shell are contacted and short-circuited with each other.

In the case of a shielded connector in which an end portion of a shielded cable is shielded by an outer conductor shell or shielded cover, usually, it is necessary to interpose an insulation protective member between an inner conductor terminal and an outer conductor shell or between an inner conductor terminal and a shell cover so that both can not be contacted with each other. However, it becomes unnecessary to arrange such an intermediate member. Therefore, the shielded connector can be downsized, and the number of connector parts cam be reduced and the number of manufacturing processes can be reduced.

According to aspect 2 of the present invention, there is provided a shielded connector in which a shell cover for electromagnetically shielding the connecting portion of the inner conductor terminal housed in the dielectric housing with the signal conductor of the cable is arranged in the exposed portion of the connecting portion in such a manner that the shell cover is engaged with the outer conductor shell. Even when an upper portion of the exposed portion of the connecting portion, in which the inner conductor terminal in the dielectric housing and the cable signal conductor are connected with each other, is not shielded by the outer conductor shell, when the shell cover is engaged with and attached to the outer conductor shell, this connecting portion can be electromagnetically shielded. Therefore, the reliability of connection of the end portion of the shielded cable can be ensured. Further, in this case, the short circuit preventing piece is arranged on the side wall face. Accordingly, it is possible to prevent the inner conductor terminal housed in the dielectric housing from rising upward, and it becomes possible to avoid that the inner conductor terminal and this shell cover are contacted and short-circuited with each other. Accordingly, the reliability of connecting the end portion of the shielded cable can be enhanced.

According to aspect 3 of the present invention, there is provided a shielded connector in which a cross section of the short circuit preventing piece, which is arranged in the dielectric housing composing the shielded connector, is formed into an umbrella-shape so that the short circuit preventing piece can be engaged with the inner conductor terminals arranged on both sides of bulkheads. Since the inner conductor terminal housed in this dielectric housing is engaged with this short circuit preventing piece, the inner conductor terminal can be positively prevented from rising upward, so that the reliability of connecting the end portion of the cable can be further enhanced. Further, when the end portion of the signal conductor of the cable is connected, the signal conductor can be smoothly inserted into and connected with the inner conductor terminal from an upper portion. Therefore, the working efficiency and productivity can be enhanced when the end portion of the shielded connector is connected. In addition to that, in the case where an inner conductor terminal having a pressure blade is used, the signal conductor to be inserted can be smoothly guided by this umbrella-shaped short circuit preventing piece, and further the signal conductor can be accurately positioned at the center of the pressure blade. Therefore, the reliability of connection can be more enhanced.

What is claimed is:

1. A shielded connector comprising:
a dielectric housing,
an inner conductor terminal electrically connected to an end portion of a signal conductor of a shielded cable is housed in said dielectric housing, and
an outer conductor shell attached to said dielectric housing, and
a short circuit preventing piece for restricting said inner conductor terminal from rising so as to prevent said outer conductor shell and said inner conductor terminal from being short-circuited with each other, wherein
said short circuit preventing piece is arranged on a side wall face of an exposed portion of a connecting portion of said inner conductor terminal in said dielectric housing with said signal conductor of said shielded cable.

2. The shielded connector according to claim 1, wherein
a shell cover for electromagnetically shielding said connecting portion of said inner conductor terminal housed in said dielectric housing with said signal conductor of said cable is arranged in an exposed portion of said connecting portion in such a manner that said shell cover is engaged with said outer conductor shell.

3. The shielded connector according to claim 1, wherein
a cross section of said short circuit preventing piece is formed into an umbrella-shape so that said short circuit preventing piece is engaged with said inner conductor terminals arranged on both sides of bulkheads.

4. The shielded connector according to claim 1, further comprising:
a drain conductor terminal and inner conductor terminals.

5. The shielded connector according to claim 4, wherein
an end portion of said drain conductor terminal comes into pressure contact in a same way as said inner conductor terminal.
